(19) United States
(12) Patent Application Publication
(10) Pub. No.: US 2010/0217635 A1
(43) Pub. Date: Aug. 26, 2010

(54) PACKAGE SHIPPING METHOD

(75) Inventor: Ronald Spears, New Canaan, CT (US)

Correspondence Address: AT&T Legal Department - JW;Attn: Patent Docketing, Room 2A-207, One AT&T Way, Bedminster, NJ, 07921, US

(73) Assignee: AT&T Intellectual Property I, L.P., Reno, NV (US)

(21) Appl. No.: 12/392,868

(22) Filed: Feb. 25, 2009

(51) Int. Cl. G06Q 10/00

(52) U.S. Cl. 705/7

(57) ABSTRACT

A package delivery method and enterprise include receiving a shipping request including recipient information indicative of an intended recipient of the package, associating a dynamic address with the recipient, and generating an initial routing plan based on the dynamic address. The initial routing plan may including a plurality of routing segments derived from hierarchical addressing. In response to a change of either (a) a physical address associated with the dynamic address and (b) an availability of at least one of the plurality of routing segments, at least one of the plurality of routing segments may be modified.

### BACKGROUND

1. Field of the Disclosure

The disclosed subject matter relates to package shipping and, more particularly, automated and dynamic techniques for routing packages.

2. Description of the Related Art

Package shipping enterprises ship packages to destination locations associated with the intended recipients. Routing of packages is generally determined when the package is received and entered into a package shipping database. The route assigned to a package is generally static, offering the sender little or no opportunity to change the delivery location while the package is in transit. Re-routing is also difficult when bad weather closes or slows a specific shipping route. Moreover, the traditional package shipping paradigm is the delivery of a package to a home or business street address, but such a paradigm does not adequately accommodate mobile users, who may spend as much time away from home as at home.

### BRIEF DESCRIPTION OF THE DRAWINGS

FIG. 1 is a block diagram of selected aspects of an embodiment of a package shipping enterprise including a dynamic route generator;

FIG. 2 is a representation of a dynamic location database for use with the dynamic route generator of FIG. 1;

FIG. 3 is a representation of selected aspects of an embodiment of a routing segment database for use with the dynamic route generator of FIG. 1;

FIG. 4 illustrates an exemplary hierarchical address suitable for use in conjunction with generating multiple-segment and dynamic route plans;

FIG. 5 is a flow diagram depicting selected aspects of an embodiment of a method for employing a dynamic address for the destination address of a package;

FIG. 6 is a flow diagram depicting selected aspects of an embodiment of a method for employing hierarchical addresses in a package shipping enterprise;

FIG. 7 is a flow diagram depicted selected aspects of an embodiment of a method for employing a dynamic address and a proxy for an intended recipient to enable presence-based package shipping;

FIG. 8 is a flow diagram illustrating selected aspects of an embodiment of a method for shipping packages by establishing an initial destination and then monitoring a proxy for the recipient to trigger modifications of the destination address and the corresponding routing plan; and

FIG. 9 is a block diagram of selected elements of an exemplary general purpose data processing system.

### DESCRIPTION OF THE EMBODIMENTS

In one aspect, a disclosed method for delivering a package to a recipient includes receiving a shipping request containing recipient information indicative of an intended recipient and associating a dynamic address with the recipient. An initial routing plan is generated based on the dynamic address. The initial routing plan may include a plurality of routing segments. If a physical address associated with the dynamic address and/or an availability of any of the routing segments changes sufficiently, routing segments may be modified dynamically. The recipient information may be selected from an email address associated with the recipient, a mobile or landline telephone number associated with the recipient, and a network address associated with the recipient.

In another aspect, a disclosed dynamic route generator suitable for use in a package delivery enterprise includes a processor and computer readable storage accessible to the processor. The storage includes processor executable instructions for associating a dynamic destination with a proxy for an intended recipient of a package and determining a last reported physical location for the proxy. Initially, the dynamic route generator may designate the last reported physical location as the dynamic destination. Based on a comparison of the dynamic destination and an origin location associated with the package, an initial routing plan including a plurality of routing segments is generated. The dynamic route generator may monitor the last reported physical location of the proxy. If a change of the last reported physical location proxy is detected prior to delivery of the package, the dynamic route generator may then determine whether to modify the routing plan. If the routing plan is modified, at least one of the routing segments may be modified and the modifications may be forwarded to a carrier.

The proxy for the intended recipient may be a mobile telephony device associated with the recipient an email address, a text address, and so forth. In this case, determining the last reported physical location of the proxy may be based, at least in part, on physical location indications transmitted by the mobile telephony device. The physical location indications may include global positioning system indications, as an example. In some embodiments, recipient approval may be required for a proposed modification of the routing segments.

Determining whether to modify the routing plan may include accessing a dynamic update setting associated with the intended recipient and determining whether to modify based at least in part on said dynamic update setting. The last reported physical location may be a hierarchically formatted indication of the physical location, wherein the hierarchical formatting includes a plurality of region segments wherein a successive region segment represent a region within a region represented by a preceding region segment.

In another aspect, a disclosed package delivery method includes associating a hierarchical address with the recipient. When a package shipping request, including recipient information indicative of a recipient of the package is received. The hierarchical address may include a plurality of region segments, where region segments correspond to geographical regions. In some implementations, a geographical region associated with one of two adjacent region segments is contained within a geographical region associated with the other of the two adjacent region segments.

A routing plan may be generated based on a comparison between a hierarchical address for the origin of the package and the destination hierarchical address. The routing plan may include at least one routing segment for each pair of adjacent region segments in the hierarchical address. The routing plan may be stored in computer readable storage.

Associating the hierarchical address with the recipient may include associating the hierarchical address with a street address or a dynamic address. Associating the hierarchical address with the recipient may include associating the hierarchical address with a virtual address associated with the recipient. The virtual address may correspond to a mobile telephone device associated with the recipient or a phone number associated with the recipient. The depicted method may further include dynamically altering at least one or more of the routing segments in the routing plan in response to detecting a sufficient change in a physical location associated with the virtual address.

In some embodiments, a stack of shipping labels is generated when the route plan is initially establish. Each of the labels may correspond to a routing segment and may indicate the origins and a destination for the corresponding routing segment. In these embodiments, the disclosed subject matter may include a dynamic route generator. The method may further include applying the label stack to the package and removing a label from the label stack at a conclusion of each segment to reveal an underlying label corresponding to a next segment.

In some embodiments, the recipient information may also include an indication of a level of service, in which case, generating the routing plan may be based, at least in part, on the indicated level of service.

In still another aspect, a computer readable storage medium includes computer executable instructions for facilitating delivery of a package to an intended recipient. The instructions include instructions to acquire a last reported physical location associated with a proxy for the intended recipient and generate an initial routing plan. The current physical location of the proxy is monitored and a determination regarding changing the routing plan is made. When a change in the physical location occurs before the package is delivered to the intended recipient, the method includes determining whether to modify the routing plan occur.

In some embodiments, generating an initial set of shipping labels includes a label for each of the routing segments in the initial routing plan and generating a modified set of shipping labels responsive to modifying the routing plan.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

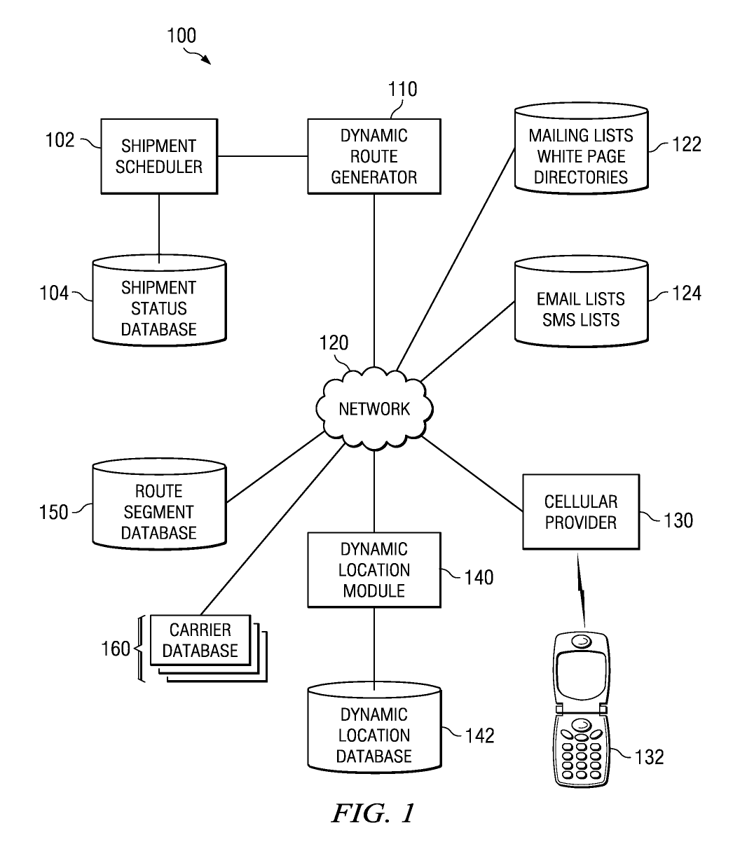

Turning now to the drawings, FIG. 1 is a block diagram depicting selected aspects of an embodiment of a package shipping enterprise 100 that supports dynamic recipient addressing, dynamic package routing, and hierarchical addressing methods as described herein. Package shipping enterprise 100 as depicted in FIG. 1 includes a shipment scheduler 102 having access to a shipment status database 104. Shipment scheduler 102 and shipment status database 104 represent resources of package shipping enterprise 100 that schedule and track the actual shipment of packages. In the depicted embodiment, shipment scheduler 102 implements dynamic addresses and dynamic routing via dynamic route generator 110.

Dynamic route generator 110 as depicted in FIG. 1 interacts with various database that enable dynamic route generator 110 to accept and process packages using a dynamic data construct, referred to herein as a dynamic address. Dynamic route generator 110 associates the dynamic address to a physical address. Until the package is delivered to the intended recipient, dynamic route generator 110 monitors to detect whether a physical location associated with the intended recipient has changed. When a physical address associated with a dynamic address changes, dynamic route generator 110 evaluates the change to determine whether the change is sufficient to necessitate a change in a routing plan. If so, dynamic route generator 110 may then modify one or more routing segments in a multi segment routing plan convey the modification as necessary, e.g., convey the modifications to the recipient and/or any carriers affected by the modification.

In addition, route plan modifications made by dynamic route generator 110 may cause package shipping enterprise 100 to generate a set of one or more routing segment labels that are consistent with the modified route plan. Some embodiments that employ routing segment labels may employ or support a hierarchical addressing paradigm.

Hierarchical addressing of packages may include a conversion of conventional indicators of physical locations such as street addresses to a numeric address analogous in some ways to a network address in the field of data processing networks. In the package shipping context, a hierarchical address may include two or region segments separated by a predetermined demarcation symbol such as a period, comma, or the like. The first regent segment value corresponds to the largest geographic region represented by the hierarchical address. The second regent segment value corresponds to the next largest geographic region represented by the hierarchical address, and so forth. In some embodiments, the region segments are defined so that a lower tier region segment is always fully enclosed within a higher tier region segment. In these embodiments, a hierarchical address may include a series of regions segments identifying a physical location, e.g., a package destination, as a series of increasingly precise geographic regions. Dynamic route generator 110 may leverage hierarchical addressing by generating routing plans and the component routing segments of a routing plan based on a comparison of the hierarchical addresses.

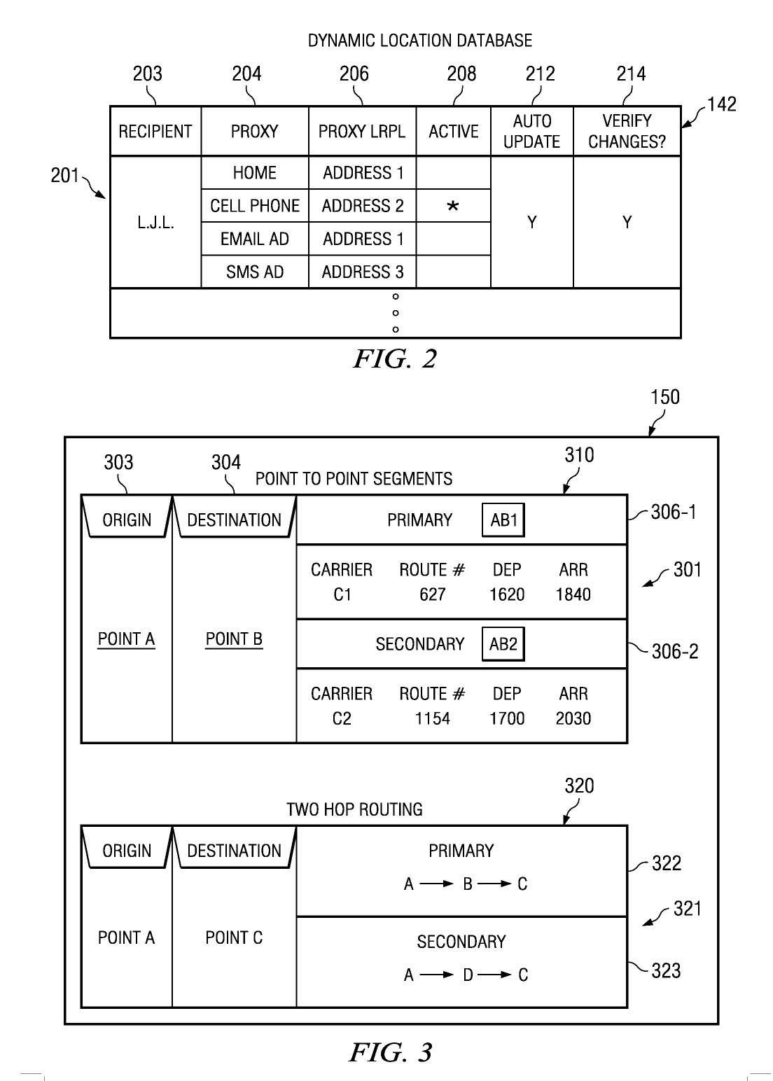

Dynamic route generator 110 as depicted in FIG. 1 further includes a dynamic location module 140 in communication with dynamic route generator 110 via a network 120, which may include a public network such as the Internet, a private network such as a corporate intranet, or a combination thereof Dynamic location module 140 operates to maintain a dynamic location database 142 containing information pertaining to an individuals package delivery status and location as described in more detail with respect to FIG. 2. In some embodiments, dynamic location module 140 is configured to interact with various resources, some of which may be external resources provided by third parties, to monitor the associations between dynamic addresses and physical locations. For example, dynamic route generator 110 as depicted in FIG. 1 may be configured to communicate, via network 120, with a directory database 122, a lists database 124, and a cellular provider 130. Directory database 122 may encompass various public and/or private directory listing database including white pages directories, mailing lists, and so forth. Directory database 122 may provide at least some type of correlation between an individual and a physical location of a proxy for the individual. To the extent that white pages include street address information, for example, those directories may provide a link between an individual, a telephone number for the individual, and a street address. Similarly, mailing lists may provide an association between an individual and a street address.

Lists database 124 may provide physical location information by way of a different set of proxies for the individual. Lists database 124 may, for example, provide information associating an email address or SMS address with an individual and a street address for the individual. Because emails and SMS addresses are not physically tied to a particular location, lists database 124 may monitor these proxies and maintain a physical address that tracks a current location of the own. Lists database 124 may, for example, be able to recognize the email address of the email's author. Lists database 124 may then determine or estimate the email author's physical location on the basis of a network resource that the author invoked.

Dynamic location module 140 may access other types of network resources as well. For example, an individual may maintain a “.tel” domain name or a .tel address for purposes of managing all of the ways that the individual communicates with others. In some embodiments, the individual may elect to expose some or all of the individuals .tel domain or .tel address to third parties and, in these embodiments, dynamic location module 140 may leverage the individual's .tel resource(s) in conjunction with dynamic route generator 110.

Cellular provider 130 may operate in conjunction with a still more mobile form of proxy, namely, a mobile telephony device 132. In some embodiments, dynamic route generator 110 may, with the assistance of cellular provider 130, monitor the current location of mobile telephony device 132 that is owned or leased by, operated by, or otherwise associated with an individual. Dynamic location module 140 may receive information indicative of the location of mobile telephony device 132 from time to time and update its location information accordingly. In these embodiments, the location information may come from mobile telephony device 132 itself in the form of GPS data, or, provided by cellular provider 130 using cell tower triangulation, cell location, or some other technique.

FIG. 1 further illustrates carrier database 160 and a route segment database 150 that may be employed by dynamic route generator 110, dynamic location module 140, or both. Carrier database 160 encompasses route schedule information for a set of one or more types of carriers. In the case of airline carriers, for example, carrier database 160 would include flight schedule information, fare information, and so forth. Similarly, in the case of a motorized vehicle carrier such as a bus company, carrier database 160 might include a schedule of routes and fares for various bus routes. Analogous types of information may be available for other types of carriers including, e.g., trucking carriers, train carriers, ship carriers, and the like.

Turning now to FIG. 2 a portion of an exemplary implementation of dynamic location module 140 is depicted. Dynamic location module 140 includes a plurality of entries 201 (one of which is depicted). In the depicted implementation, an entry 201 corresponds to a potential recipient of a package. In the depicted embodiment, an entry 201 has various fields including a recipient field 203, a proxy field 204, an LRPL field 206, an active field 208, an auto update field 212, and a verify changes field 214. The proxy field 204 may itself include multiple entries including an entry for one or more proxies for the recipient. As shown in FIG. 1, a proxy can be any physical or logical entity that is associated with the recipient. The entries 201 depicted in FIG. 2 includes four proxies, a home address, a cellular phone number, and email address, and a short messaging service or text address. The set of proxies depicted for entry 201 are illustrative only and entries 201 may have more, less, and/or different proxies than the proxies shown in FIG. 1.

Dynamic location database 142 as shown in FIG. 2 further includes a active field 208, an auto update field 212, and A verify changes field 214. The active field 208 includes data indicating which of the proxies in LRPL field 206 is the active proxy. In FIG. 2 as shown, for example, the cell phone proxy in proxy field 204 is the active proxy. When dynamic route generator 110 is monitoring the physical data of a proxy for a package recipient, for example, auto update field 212 indicates which proxy dynamic route generator 110 is monitoring. The auto update field 212 as shown is a binary indicator of whether the individual associated with entry 201 authorizes automatic updates of LRPL field 206. When auto update field 212 indicates a Y as in FIG. 2, dynamic route generator 110 may automatically respond to a change in a physical location of the active proxy for the package recipient by updating LRPL field 206 or taking other action. Similarly, verify changes field 214 is a binary indicator of whether the user associated with entry 201 requires changes to LRPL field 206 and active field 208 to be conveyed to the user.

The dynamic route generator 110 operates with directory database 122, lists database 124, cellular provider 130, and dynamic location database 142 via dynamic location module 140 to maintain LRPL field 206 in dynamic location database 142. The LRPL field 206 in dynamic location database 142 indicates a last reported physical addresses last reported physical location. Based on the LRPL of the active proxy for a package recipient, dynamic route generator 110 can determine whether a dynamic address associated with a package needs to be updated to reflect a recently changed physical location. If, for example, an intended recipient of a package uses his cellular telephone as the active dynamic proxy and the user travels a substantial distance with his cell phone, dynamic route generator 110 will ultimately detect that a physical location with respect to the recipient's proxy has changed. If the change is sufficiently substantial, the change of location for a proxy may necessitate a change in transit plans.

FIG. 3 depicts an exemplary embodiment of information storage in route segment database 150. The route segment database 150 may include information that enables dynamic route generator 110 to create a routing plan between an origin and a dynamic destination. When dynamic route generator 110 determines an initial routing plan based on an initial assignment of a physical address to the dynamic address, the routing plan may include one or more routing segments. If the recipient travels or decides to have a package delivered to a secondary location, dynamic route generator 110 may be required to modify the routing plan, for example, by changing the delivery address. In any of these cases, it may be necessary or more efficient to alter the routing plan. Generating an initial plan and later modifying the plan both may require the user to determine a modified routing plan.

As depicted in FIG. 3, route segment database 150 includes a point to point segment table 310 and a two hop segment table 320 to facilitate and support the generation of initial routing segments and the modification of existing routing segments. The point to point segment table 310 is useful in determining routing segments for point-to-point or “one hop” journeys. As depicted in FIG. 3, point to point segment table 310 includes a plurality of entries entry 301, only one of which is shown in FIG. 3, indicating routing information from an origin (Point A) to a destination (Point B). The entry 301 as shown includes an original field 303, a destination field 304 and one or more 306 including a primary segment 306-1 and a secondary segment 306-2. Each entry 301 corresponds to a segment from Point A as indicated in original field 303 to a destination point B, as indicated in destination field 304. For each one hop entry, entry 301 as shown includes detail for one or more carriers that can accommodate the journey. The primary segment 306-1, for example, indicates a commercial flight by carrier, route #, departure time, and arrival time. The point to point segment table 310 may be consulted when, for example, when a primary flight for a routing segment is delayed or canceled. In this case, the package may be re-routed to a different flight (or other type of transportation) by referring to point to point segment table 310.

The two hop segment table 320 indicates alternative routing options that are useful when an entire city or region is experiencing delays due to weather or some other factor. The two hop segment table 320 is organized as a set of entries 321. Each entry includes an origin field and a destination field. The entries 321 depicted, for example, defines a primary routing 322 for the two hop routing segment from Point A to Point C through Point B. The primary routing 322 of a package may include a pair of routing segments to ship the package from Point A to Point C through Point B.

When dynamic route generator 110 must route a package from Point A to Point C, it will attempt to select primary routing 322 as the routing path from Point A to Point C. The dynamic route generator 110 can then consult with point to point segment table 310 to determine the best transportation options, namely, the primary segment 306-1 for the segment from Point A to Point B and the flight from Point B to Point C. If, however, Point B is fogged in or otherwise experiencing delays, dynamic route generator 110 may consult two hop segment table 320 to determine a secondary routing secondary routing 323 from Point A to Point C through Point C. After dynamic route generator 110 identifies secondary routing secondary routing 323, dynamic route generator 110 may access point to point segment table 310 to identify the primary routing segment from Point A to Point D and from Point D to Point A (these entry 301 are not shown in FIG. 3).

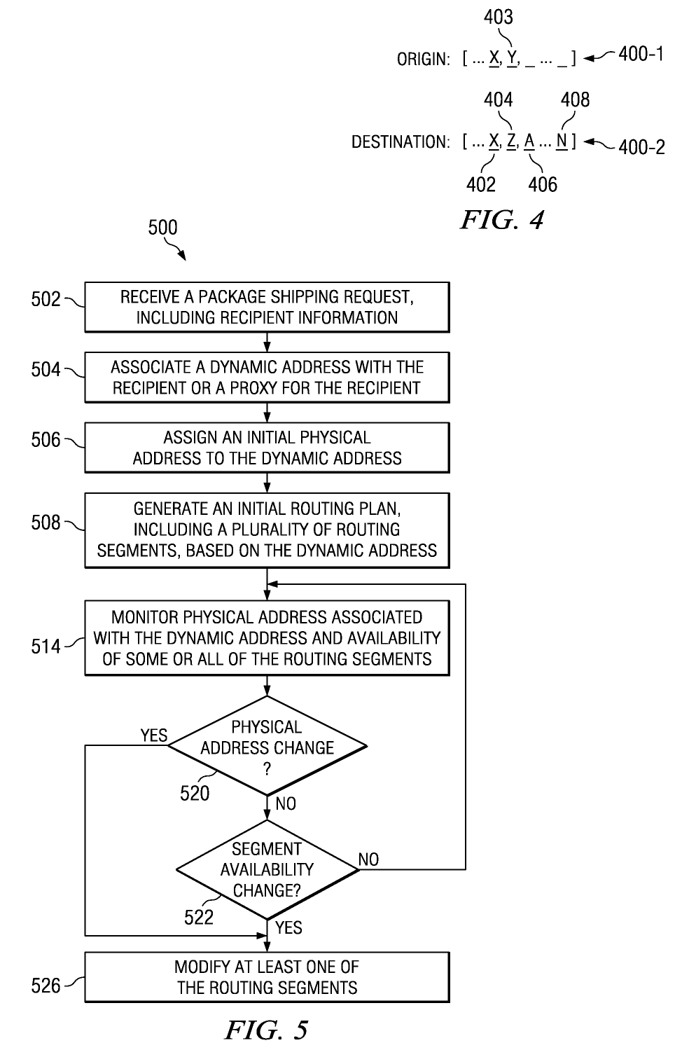

Turning now to FIG. 4, an implementation of an exemplary hierarchical address is described. Origin hierarchical address 400-1 may be associated with the origin while destination hierarchical address 400-2 corresponds to the destination. The dynamic route generator 110 may be able to leverage the structure of 400 to facilitate routing planning and routing segment creation. As depicted in FIG. 4, a method to develop the routing plan may include comparing origin hierarchical address 400-1 and destination hierarchical address 400-2 on a region segment basis to discover the routing segment from one point to another. For example, the origin hierarchical address 400-1 and destination hierarchical address 400-2 share common high order region segments (reference numeral 402). The high order region segments that are shared by a recipient can generally be discarded since it is unlikely that anyone will need transportation within a region segment. Region segments 403 and 404 represent the highest order region segments shared between the two friends.

The routing segment or segments involved in going from A to C may be determined algorithmically. The first segment would be from the highest order non-matching region segment of the origin to the same region segment of the destination, i.e., from Y 403 to Z 404. After the first segment is complete, the routing plan would be generated by each consecutive step in the destination hierarchical address 400-2, e.g., from Z 404 to A 406 . . . to N 408. In this manner, the point to point segment table 310 and two hop segment table 320 facilitate the ability of dynamic route generator 110 to convert routing plans to actual flight and trips maintained by the carriers carrier database 160.

Turning now to FIG. 5, selected aspects of an embodiment of a package shipping method 500 are illustrated. The illustrated embodiment of method 500 includes associating (block 502) a dynamic destination with a proxy for an indicated recipient of the package. A last reported physical location (LRPL) of the proxy is determined and designated (block 504) as an initial value of the dynamic destination. Thereafter, a routing plan, including a plurality of routing segments, is generated (block 506) based on a comparison between the dynamic destination and an origin location associated with the package.

The proxy LRPL is then monitored (block 508). When a change of the proxy LRPL is detected prior to delivery of the package (510), method 500 as shown determines (block 526) whether to modify one or more routing segments of the routing plan. When a determination to modify has been made (block 530), method 500 further includes communicating (block 542) information regarding the modifications to a carrier.

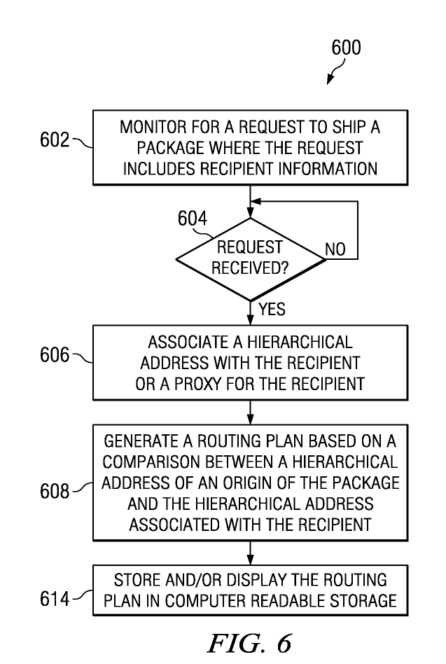

Referring now to FIG. 6, a flow diagram illustrating selected aspects of an embodiment of a package delivery method 600. Method 600 encompasses the use of hierarchical addressing to generate a routing plan. As depicted in FIG. 1, method 600 includes monitoring (block 602) for a request to ship a package. The package shipping request may include information indicating a recipient of the package or a proxy for the recipient. When a package shipping request is detected (block 604), a hierarchical address is associated (606) with the recipient or recipient proxy.

The hierarchical address may be comprised of or consist of two or more region segments. The region segments may correspond to geographical regions. In some embodiments, a geographical region associated with a first of two adjacent region segments is contained within a geographical region associated with the second region segments, i.e., each successively smaller region is fully contained within the immediately large region segment.

Method 600 as depicted further includes generating (block 608) a routing plan based on a comparison between a hierarchical address associated with an origin of the package and the recipient hierarchical address. The routing plan may include one or more routing segments for each pair of adjacent region segments in the hierarchical addresses. The routing plan may then be stored (block 614) to memory or storage and/or displayed on a display.

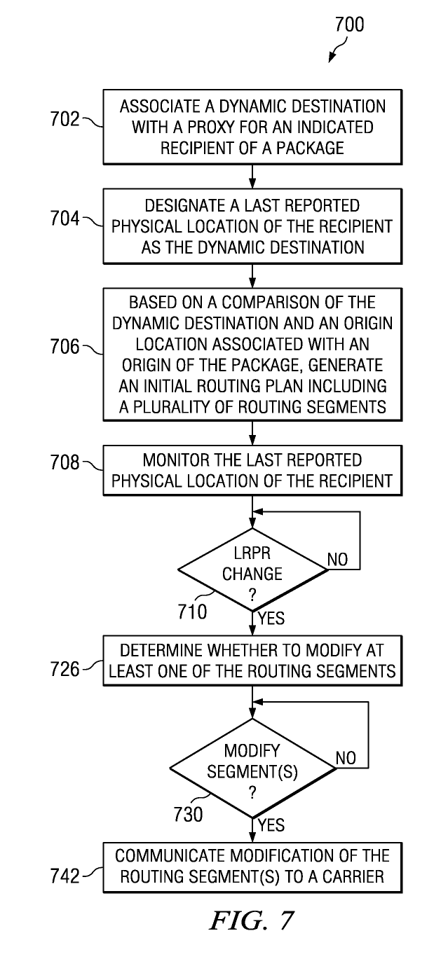

Turning now to FIG. 7, selected elements of an embodiment of a method 700 for shipping packages to their intended recipients are illustrated. Method 700 as depicted in FIG. 7 includes receiving (block 702) a shipping request. The shipping request may include recipient information indicative of a recipient of the package. A dynamic address is associated (block 704) with the recipient or with a proxy for the recipient and an initial physical address is assigned (block 706) to the dynamic address. An initial routing plan is then generated (block 708) based on the dynamic address. The initial routing plan may include multiple routing segments.

The depicted embodiment of method 700 further includes monitoring (block 714) the physical address associated with the recipient or the proxy for the recipient and the availability of at least some of the routing segments in the routing plan. If either the physical address of the recipient or recipient proxy (block 720) or the availability of any routing segment (block 722) changes, method 700 as shown may then modify (block 726) one or more of the routing segments.

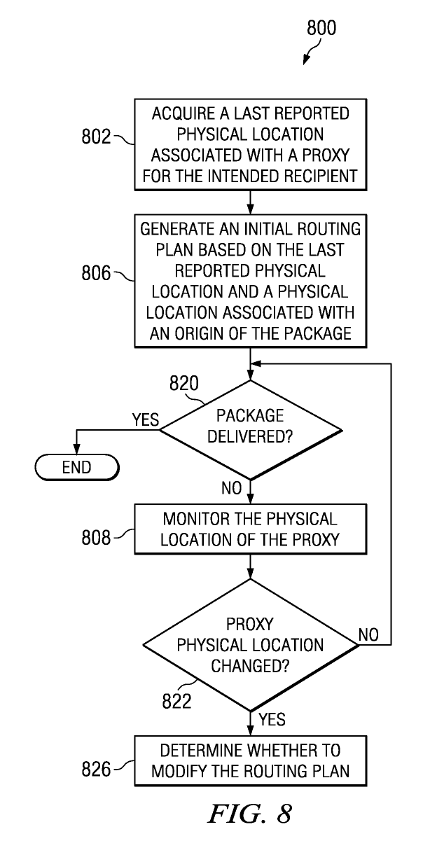

Turning now to FIG. 8, selected aspects of an embodiment of a dynamic destination shipping method 800 are presented. In the depicted embodiment, method 800 includes acquiring (block 802) a LRPL of a proxy for the intended recipient of a package shipment. An initial routing plan is generated (block 806) based on the proxy LRPL and a physical location associated with an origin of the package. While the package remains undelivered (block 820), the physical location of the proxy is monitored (block 808). If a physical location change is detected (block 822), method 800 determines (block 826) whether to modify the routing plan and take appropriate action thereafter. e.g., notify one or more carriers affected by the modification, generate a new set of package labels, and so forth.

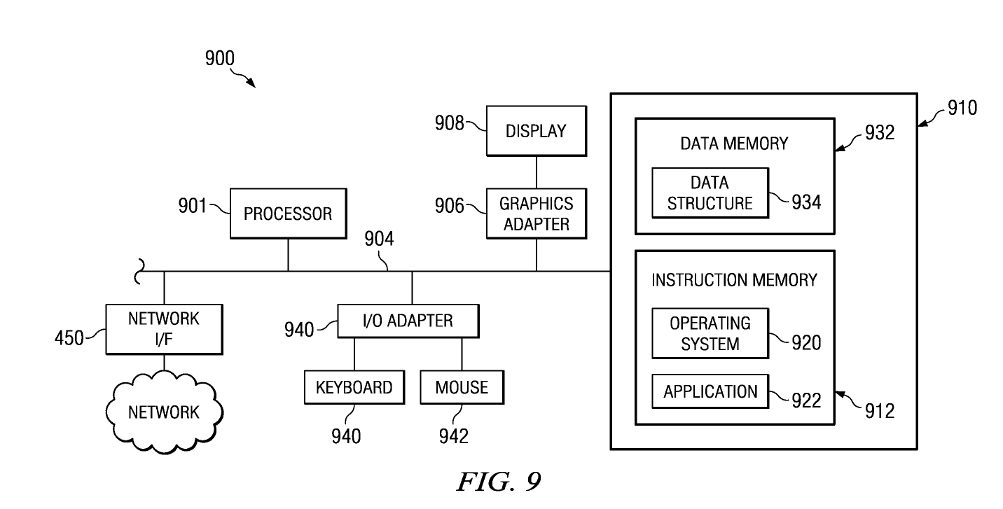

Referring now to FIG. 9, a block diagram of selected elements of a data processing system 900 is presented. Data processing system 900 as depicted in FIG. 4 is an exemplary general purpose data processing system that encompasses the data processing systems depicted in FIG. 1 including, as an example, dynamic route generator 110. In the depicted embodiment, data processing system 900 includes a processor 901 and a computer readable storage 910 accessible to processor 901 via a bus 904.

Storage 910 encompasses various types of computer memory media including volatile memory such as dynamic and static random access memory, persistent memory including magnetic drives, solid state drives, flash memory, read only memories including programmable and/or erasable read only memories, optical storage media such as compact discs and digital versatile discs, magnetic tape media and so forth. Storage 910 is operable to store programs, i.e., computer executable instructions, and data and data processing system 900 as depicted in FIG. 4 includes an instruction memory 912 and a data memory 932. Although FIG. 4 distinguishes between instruction memory 912 and data memory 932, this distinction may be an organizational distinction only and may or may not reflect a distinction in terms of any physical, logical, or virtual architecture. Instruction memory 912 as shown includes an operating system 920 and an application 922 while data memory 932 is shown as including a data structure 934. Application 922 may represent substantially any application executable by data processing system 900 including, for example, dynamic location module 140 of FIG. 1.

Data processing system 900 as shown in FIG. 9 further includes a graphics adapter 906, a network interface 950 and an I/O adapter 940 all connected to bus 904. Graphics adapter 906 controls a display 908 to provide visual output in the form of computer graphics including graphical user interfaces, still video images, video streams, and so forth. Network interface 950 is operable to connect data processing system 900 and processor 901 to an external network including any IP based network such as the Internet, a corporate intranet, an Ethernet-based local area network, and so forth. I/O adapter 940 interfaces with an input device 942 including keyboards, point devices, and so forth.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A package delivery method, comprising:
responsive to receiving a request to ship a package, the request including recipient information indicative of a recipient of the package, associating a hierarchical address with the recipient, the hierarchical address including a plurality of region segments, wherein region segments correspond to geographical regions and wherein a geographical region associated with one of two adjacent region segments is contained within a geographical region associated with the other of the two adjacent region segments;
generating a routing plan based on a comparison between a hierarchical address of an origin of the package with the destination hierarchical address, wherein the routing plan includes at least one routing segment for each pair of adjacent region segments in the hierarchical address; and
storing the routing plan in computer readable storage.

2. The method of claim 1, wherein associating the hierarchical address with the recipient includes associating the hierarchical address with a street address associated with the recipient.

3. The method of claim 1, wherein associating the hierarchical address with the recipient includes associating the hierarchical address with a virtual address associated with the recipient.

4. The method of claim 3, wherein the virtual address corresponds to a mobile telephone device associated with the recipient.

5. The method of claim 4, wherein the virtual address comprises a phone number associated with the recipient.

6. The method of claim 3, further comprising, in response to determining a change in a physical location associated with the virtual address, dynamically altering at least one or more of the routing segments in the routing plan.

7. The method of claim 1, further comprising generating a label stack include a plurality of labels, wherein each of the plurality of labels corresponds to one of the at least one routing segments and indicates an origin and a destination for the corresponding routing segment.

8. The method of claim 7, further comprising:
applying the label stack to the package; and
removing a label from the label stack at a conclusion of each segment to reveal an underlying label corresponding to a next segment.

9. The method of claim 8 wherein the recipient information further includes an indication of a level of service and wherein said generating the routing plan is based, at least in part, on said indicated level of service.

10. A method of delivering a package to a recipient, the method comprising:
receiving a shipping request including recipient information indicative of an intended recipient of the package;
associating a dynamic address with the recipient;
generating an initial routing plan based on the dynamic address, the initial routing plan including a plurality of routing segments; and
responsive to a change in at least one of (a) a physical address associated with the dynamic address and (b) an availability of at least one of the plurality of routing segments, modifying at least one of the plurality of routing segments.

11. The method of claim 10, wherein the recipient information is selected from the group consisting of an email address associated with the recipient, a mobile or landline telephone number associated with the recipient, and a network address associated with the recipient.

12. A dynamic route generator suitable for use in a package delivery enterprise, the dynamic route generator comprising:
a processor; and
computer readable storage, accessible to the processor, including processor executable instructions for:
associating a dynamic destination with a proxy for an indicated recipient of a package;
determining a last reported physical location (LRPL) for the proxy;
initially designating the proxy LRPL as the dynamic destination;
based on a comparison of the dynamic destination and an origin location associated with the package, generating a routing plan including a plurality of routing segments;
monitoring the proxy LRPL;
responsive to detecting a change of the proxy LRPL prior to delivery of the package, determining whether to modify the routing plan; and
after determining to modify the routing plan, modifying at least one of the routing segments and communicating said modifying to a carrier.

13. The dynamic route generator of claim 12, wherein the proxy for the indicated recipient comprises a mobile telephony device associated with the recipient.

14. The dynamic route generator of claim 13, wherein said determining of the proxy LRPL is based at least in part on physical location indications transmitted by the mobile telephony device.

15. The dynamic route generator of claim 14, wherein the physical location indications comprise global positioning system indications.

16. The dynamic route generator of claim 12, further comprising establishing recipient approval of a proposed modification of the routing segments prior to said modifying.

17. The dynamic route generator of claim 12, wherein determining whether to modify includes accessing a dynamic update setting associated with the intended recipient and determining whether to modify based at least in part on said dynamic update setting.

18. The dynamic route generator of claim 12, wherein the last reported physical location is a hierarchically formatted indication of the physical location, wherein the hierarchical formatting includes a plurality of region segments wherein a successive region segment represent a region within a region represented by a preceding region segment.

19. A computer readable storage medium comprising computer executable instructions for facilitating delivery of a package to an intended recipient, said instructions including instructions to:
acquire a last reported physical location associated with a proxy for the intended recipient;
generate an initial routing plan based on the last reported physical location and a physical location associated with an origin of the package;
monitoring the physical location of the proxy; and
responsive to detecting a change in the physical location before delivery of the package to the intended recipient is complete, determining whether to modify the routing plan.

20. The storage medium of claim 19, wherein the initial routing plan includes a plurality of routing segments, said instructions further comprising instructions for:
generating an initial set of shipping labels including a label for each of the routing segments in the initial routing plan; and
generating a modified set of shipping labels responsive to modifying the routing plan.
